(19) United States
(12) Patent Application Publication
(10) Pub. No.: US 2010/0146500 A1
(43) Pub. Date: Jun. 10, 2010

(54) Method and system for installing a software application on a mobile computing device

(76) Inventors: Francois Malan Joubert, Stellenbosch (ZA); Marius Marais, Stellenbosch (ZA)

Correspondence Address: Goodwin Procter LLP;Attn: Patent Administrator, 135 Commonwealth Drive, Menlo Park, CA, 94025-1105, US

(21) Appl. No.: 12/597,409

(22) PCT Filed: Apr. 24, 2008
(86) PCT No.: PCT/IB08/51580

§ 371 Date: Feb. 23, 2010

(30) Foreign Application Priority Data
Apr. 25, 2007 (ZA) 2007/03405

(51) Int. Cl. G06F 9/445; H04M 3/00

(52) U.S. Cl. 717/178; 455/419

(57) ABSTRACT

A method is disclosed of installing a software application, typically a security application such as a one-time password application, on a mobile computing device such as a mobile telephone or PDA. The method comprises creating an account for a user on a network, the account having user identification data including a user name, a user e-mail address and an address of a mobile computing device of the user. An invitation message is transmitted to the user, the invitation including a link to an installation web page. A deployment server supporting the installation web page receives an initial request from the user to install the software application, transmits data to the mobile computing device of the user and receives a response from the mobile computing device, from which one or more characteristics of the mobile computing device can be determined. When a confirmatory request is received at the deployment server from the mobile computing device to install the software application, the software application is transmitted to the mobile computing device and installed on it. The mobile computing device can then function like a dedicated hardware token.

### BACKGROUND OF THE INVENTION

THIS invention relates to a method and system for installing a software application on a mobile computing device.

The use of one time passwords (OTPs) to enhance security in accessing a company network, for example, is well established. The most common way of implementing a system using OTPs is to provide a hardware token to each user, which the user must plug into a terminal such as a PC which is used to access the network. The token contains hardware and software and generates a unique password each time the user accesses the network. The cost and logistics involved in providing each user of such a network with a hardware token are substantial.

It is an object of the invention to provide an alternative method and system which can be used, amongst other things, for implementing a one time password system for accessing a network.

### SUMMARY OF THE INVENTION

According to the invention there is provided a method of installing a software application on a mobile computing device, the method comprising:
creating an account for a user on a network, the account having user identification data associated therewith including a user name, a user e-mail address and an address of a mobile computing device of the user;
transmitting an invitation message to the user, the invitation including a link to an installation web page;
receiving, at a deployment server supporting said installation web page, an initial request from the user to install the software application;
transmitting data to the mobile computing device of the user and receiving a response from the mobile computing device from which one or more characteristics of the mobile computing device can be determined;
at the deployment server, receiving a confirmatory request from the mobile computing device to install the software application;
transmitting data comprising the software application from the deployment server to the mobile computing device of the user; and
installing the application software on the mobile computing device of the user.

The mobile computing device of the user is preferably a mobile telephone, a PDA or another mobile computing device with wireless connectivity.

The software application may be security software, such as a one-time password application.

The invitation message is preferably sent to the user in the form of an e-mail message transmitted to an e-mail address of the user.

The invitation message is preferably transmitted from a secure server associated with the network.

The invitation message is preferably received by a user at a computer terminal of the user other than said mobile computing device.

The initial request from the user to install the software application is preferably transmitted from said computer terminal of the user other than said mobile computing device.

The step of receiving a confirmatory request from the user's mobile computing device to install the software application is preferably preceded by transmitting a link to the mobile computing device, the user opening the link via the mobile computing device to make the confirmatory request.

Preferably, the link is transmitted from the second, deployment server to the address of the mobile computing device as a WAP or SMS format message.

Preferably, a WAP format message is transmitted first and, if the message is not successfully received, the message is re-sent as an SMS format message.

The user preferably transmits the confirmatory request from his or her mobile computing device to the deployment server by following the link in the received WAP or SMS message.

The step of transmitting an invitation message to the user may include transmitting a security key to the user, and the step of installing the application software on the mobile computing device may include entering the security key transmitted to the user in the invitation message.

Alternatively, a security key may be transmitted or communicated to the user and the step of installing the application software on the mobile computing device may include entering the security key transmitted or communicated to the user, the security key being transmitted or communicated to the user by a method independent of the invitation message.

Further according to the invention there is provided a system for installing a software application on a mobile computing device, the system comprising:
a secure sever associated with a network, the network having a plurality of users each having an account with user identification data associated therewith including a user name, a user e-mail address and an address of a mobile computing device of the user; and
a deployment server supporting an application installation web page;
   the system being operable to:
create an account for a user on the network;
transmit an invitation message to the user, the invitation including a link to the application installation web page;
receive, at the deployment server, an initial request from the user to install the software application;
transmit data to the mobile computing device of the user and receive a response from the mobile computing device from which one or more characteristics of the mobile computing device can be determined;
receive, at the deployment server, a confirmatory request from the mobile computing device to install the software application;
transmit, from the deployment server, data comprising the software application to the mobile computing device of the user; and
install the application software on the mobile computing device of the user.

### BRIEF DESCRIPTION OF THE DRAWINGS

FIG. 1 is a simplified schematic diagram of a system for installing a security software application on a mobile computing device of a user according to the present invention;

FIGS. 2a & 2b are a flow chart illustrating major steps in the method of installing the software application;

FIGS. 3 to 7 are screen shots illustrating steps in the operation of the method; and

FIG. 8 is a composite system/process diagram illustrating major components and steps of the method and system.

### DESCRIPTION OF AN EMBODIMENT

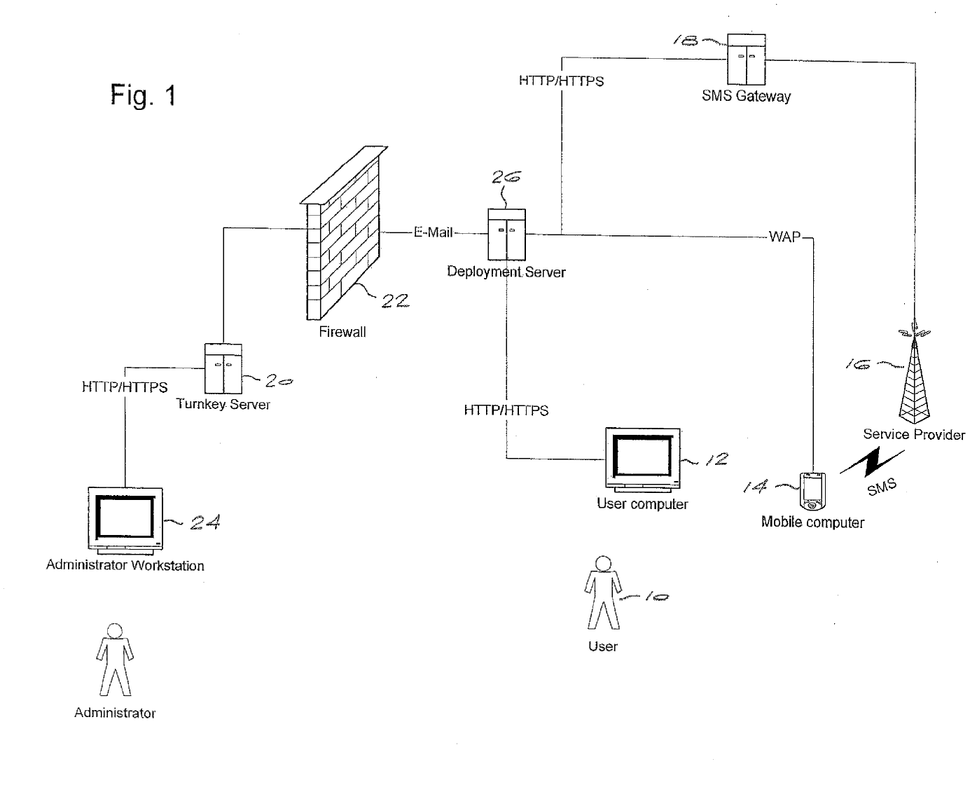

FIG. 1 shows, in a highly simplified schematic format, a system for installing a software application on a mobile computing device of a user.

For purposes of this application, the term “mobile computing device” includes, but is not limited to, mobile telephones (including cellular telephones), Personal Digital Assistants (PDAs), Smartphones, laptop or notebook computers, and other such devices. In general, devices of this kind have a user interface including a display and a keypad or keyboard, an onboard processor and software, and a communication interface which is preferably wireless.

The present invention is concerned with the installation of a software application on such a mobile computing device. One example of such an application is a one-time password (OTP) security application, and the following description is based on this example. However, those skilled in the art will understand that the invention has application to other software applications as well, such as messaging applications (e.g. MXIT) and games, for example.

In FIG. 1, a user 10 of a network, which is typically a secure computer network operated by a company or organisation, has both a main computer 12 (which could be a home computer or a network computer) and a mobile computing device 14, shown as a PDA. The device 14 is able to communicate via GSM (in this example) with a wireless telephone network 16 which includes an SMS gateway 18.

The network to which the user wishes to gain access comprises a turnkey server 20, a firewall 22 and an administrator workstation 24 (other components of the network are omitted for clarity). Associated with the network is a deployment server 26.

In the described embodiment of the invention, it is desired to deploy software on the mobile computing device of the user to enable the mobile computing device to be used as an authentication token, equivalent to a dedicated authentication token as currently used to gain access to secure networks. Essentially, the software installed on the mobile computing device transforms it into such an authentication token, similar to conventional dedicated hardware tokens but superior in several respects.

It will be appreciated that, in the example embodiment, the security of deployment of the application software to the mobile device is important. Another problem to be addressed is the sheer number of mobile telephones, PDA's and Smartphones, and the diversity of user interfaces incorporated in these devices.

In the system illustrated in FIG. 1, the turnkey server 20 is located behind a firewall 22, which protects the turnkey server from Internet-based attacks. Connected to the turnkey server 20 is a deployment server 26 which has a static IP address and open availability to the Internet.

It will be appreciated that, particularly in a system in which the software application to be installed is for purposes of security itself, secure deployment of the software is important. By using e-mail as the mechanism for distributing invitations to users to deploy the security software and to set themselves up for secure access to the network, with a separate synchronised deployment process using another computing device of each user and an alternative communication medium, this can be achieved.

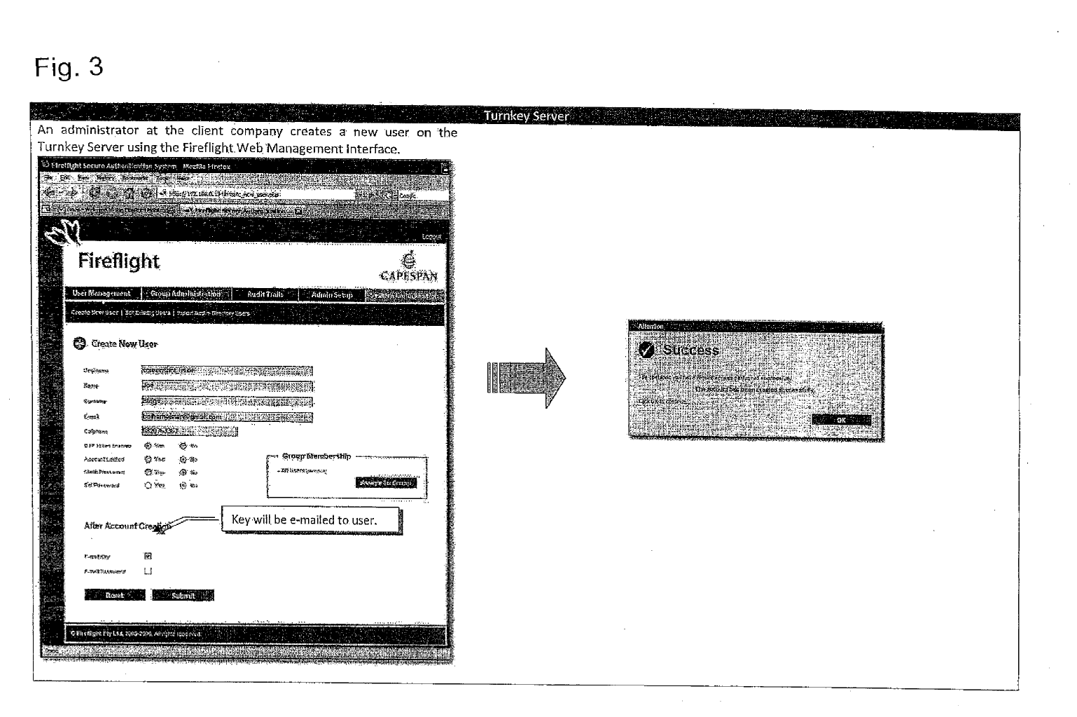

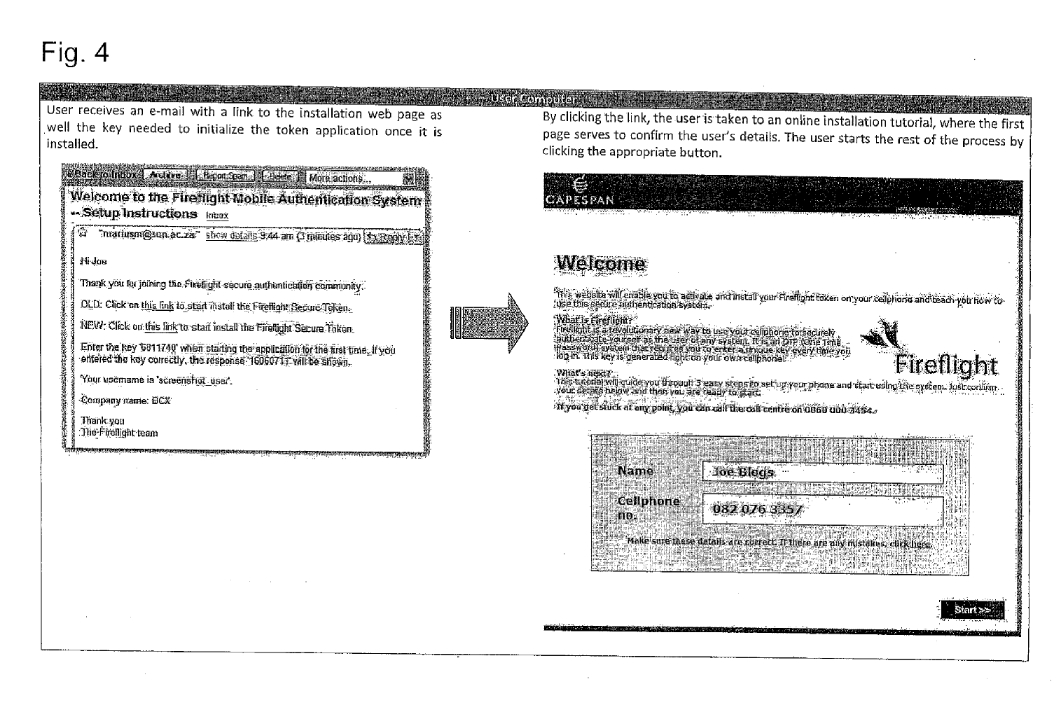

At the administrator workstation 24, user data is entered which comprises the user's name, normal e-mail address, the telephone number or other address of the user's mobile computing device 14, and other information as required by the network. FIG. 3 shows a screen shot indicating the creation of a new user account via the administrator workstation 24. When it is required to set a user up for secure access to the network, an e-mail message is sent to the user at his or her regular e-mail address, which the user can retrieve via his/her usual or main computer 12. The e-mail contains a welcoming note, instructions, a link which the user can click on to be directed to a web page offering an online installation tutorial, and a security key which will be used when installing the security software on the users mobile computing device. The screenshot of FIG. 4, left hand side, shows an example of the invitation e-mail.

The security key need not be delivered to the user by e-mail, and in some embodiments of the invention could be communicated verbally, in writing, or in some other way. The important thing is to keep the secure key and the link transmitted to the user's mobile computing device separate prior to use of the key, for security reasons.

The link that is embedded in the e-mail contains all the information needed by the deployment server to deploy the security token application successfully to that user. The following parameters are included:
Username: Ensures that the deployment report can be coupled to the user, but is not actually used anywhere during the deployment.
Full name: Allows the user to verify his or her details.
Phone number. The mobile number to which the token application should be deployed.
Token ID: A client-specific identifier that is a combination of the client ID and the ID of the algorithm to use in the token.
Key: The first half of the initialization key required before the token becomes active; saves the user the trouble of entering the whole key and prevents users from swapping or sharing token applications.
Response: Used to validate that the user entered the second part of the initialization key correctly.
Creation timestamp: Used for logging and to ensure that the link adheres to the server-specified maximum link lifetime.
Expiration timestamp: Used to ensure that the link adheres to the client-specified maximum link lifetime.
Signature: The signature that was generated when all the other parameters were signed using the secret key shared between the turnkey server and deployment server.

The e-mail can be acted upon when it is convenient for the user, and does not require the user to be interrupted.

The web page to which the user is directed by clicking the link in the invitation e-mail is supported by the deployment server 26. The web page defines an online tutorial and a validation or confirmation procedure, allowing the user to confirm his or her details, including their name and mobile telephone number. (See FIG. 4, right hand side.)

The server will validate the URL of the link in the background by calculating the signature of the URL again and comparing it to the supplied signature, and the user will be passed onto the next (or first, from his or her point of view) step. If the link is invalid, has reached one of the expiration settings or the client has exceeded their token quota, the user will be informed and asked either to try clicking the link again, or to contact their administrator, whichever may apply.

The system protects itself against users trying to install the application on unauthorized devices. The user details (such as their mobile telephone number) are included in the link, but a user cannot modify the link without the link becoming invalid. So the link doubles as a check to ensure that only the intended recipient may install the application.

The first page the user will see is a welcoming note and a quick explanation of the procedure to follow. The user will also be shown their full name and the mobile number as supplied in the link. If the user verifies that these two pieces of data are correct, the process can continue. Otherwise, the user is requested to contact his or her administrator to have their personal details updated or corrected.

By asking one or more suitable questions, the online tutorial can determine whether or not the user has set up his/her mobile computing device for GPRS or 3G connectivity. For example, the user can be asked whether he/she has ever downloaded data to their mobile computing device. If it appears from the user's response to the tutorial that the device in question has not been set up for such connectivity, the instructions are displayed to assist the user in setting up the device.

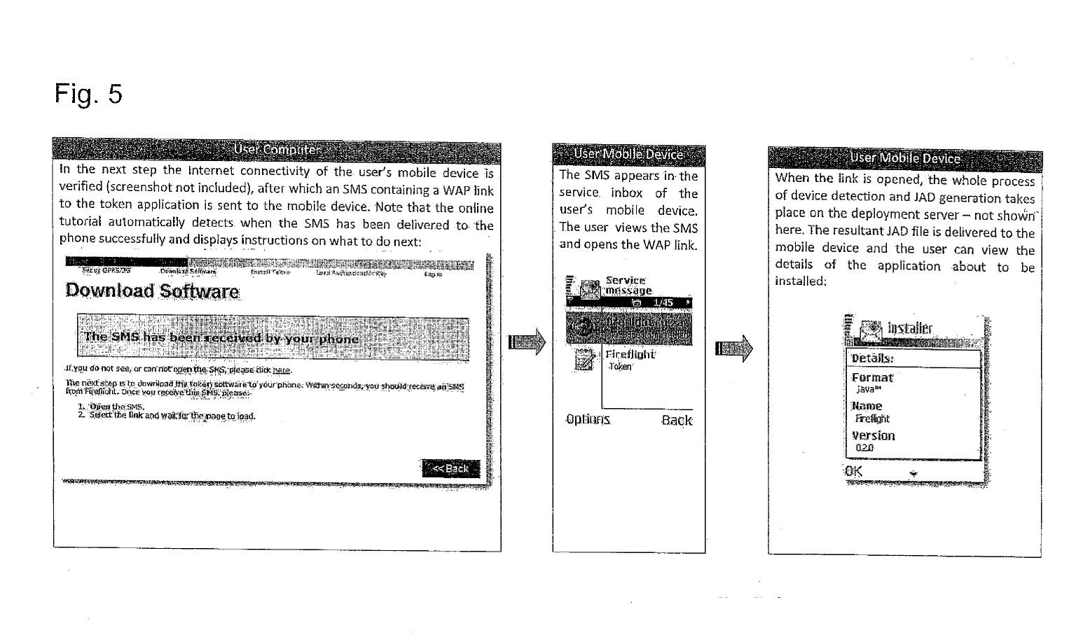

Otherwise, the next step is the transmission of a WAP or SMS message containing a clickable link which the user can follow to a WAP page on the deployment server 26. The message is sent as a special WAP push SMS, and contains a link to the WAP page which can be opened automatically on most mobile devices. (See FIG. 5.) The WAP page can determine the make and model of the user's mobile computing device and makes that information available to the general installation process. The computer-based and mobile-based processes are kept in sync, so that once the user has opened the link on the mobile computing device the computer based web page tutorial can be advanced automatically. At this point, the system knows exactly which mobile computing device is being used, enabling the installation procedure to be customised for that specific device, and avoiding the need for the user to follow a complex installation procedure with multiple alternative steps.

Once the user opens the WAP link and the mobile computing device is detected, a JAD file appropriate to the device is transmitted to the mobile device. Simultaneously, the online tutorial is advanced and is instructed as to the installation process.

This JAD file is also customized for the specific user, not only the specific phone or other device.

Although it would work to send the user a link to a generic phone detection page, it would then be necessary to send the user a second SMS (or rely on meta-refresh implementations) to actually download the security token application. To avoid this the user is sent a link to a JAD (Java Application Descriptor) file on the deployment server. Instead of just sending the user to a PHP file and outputting a JAD file, Apache's mod_rewrite extension is used to allow the deployment server to redirect the mobile device's request for a JAD file to a PHP page.

This PHP page runs the phone detection and loads the location of the application build that is appropriate to the device. If the phone cannot be detected, is not on the list or the JAD and JAR files are not available, the system degrades gracefully to a generic application build that runs on all mobile devices, possibly with a somewhat limited user interface and features. The mobile device vendor and model, as well as the actual application build and version, are stored in the session (shared with the computer) and logged in the database, allowing the necessary steps to be taken for catering for that device in the future.

The JAD file is then customized by the server according to the deployment specifications. The following properties are customized:
MIDlet-Jar-URL: This property points to the actual “jar” file containing the application and is modified to ensure that unauthorized deployments are not possible through a direct download. A useful side-effect of this is that the mobile device is prevented from caching the application.

(Again, Apache is used to rewrite this URL for the same reasons as discussed above.)
Company-Name: The friendly name of the client to which the user belongs.
Company-ID: The full token ID, which consists of the client ID and algorithm ID.
Token-Key: The first part of the initialization key.
Token-Key-Response: The response used to check the validity of the second part of the initialization key as later entered by the user.
MIDlet-Install-Notify: The URL to which the installation outcome is posted upon completion of the installation attempt.

Once the mobile device has been detected and the JAD served, the computer 12 (by sharing the session) automatically moves on to the next tutorial step—this step is the first that can be customized to each device because we now know which device we are working with.

The ability to provide customized tutorials for each of many different mobile devices is a particular advantage of the described embodiment.

The custom tutorial process uses the tutorial linking system to ensure that highly specific tutorials can be provided for mobile devices that are “tricky”, while more generalized tutorials can be provided for the rest.

Creating a generalized installation tutorial is not very difficult and would probably suffice for a technically-oriented user-base. However, non-technical users would probably need some form of technical support, which is expensive to provide. The solution is to expand the available tutorials as problems with specific mobile devices arise and then link the new pages into the tutorials for the relevant devices.

While it is possible to create a customized tutorial for every device supported, devices for which the specific tutorial steps are the same can share the same tutorial pages. A particular advantage of the described system is that it can start functioning from day one and grow as more and more tutorials are customized for different devices. This process can also be guided by considering which devices are most problematic or popular, based on the report data gathered by the deployment server.

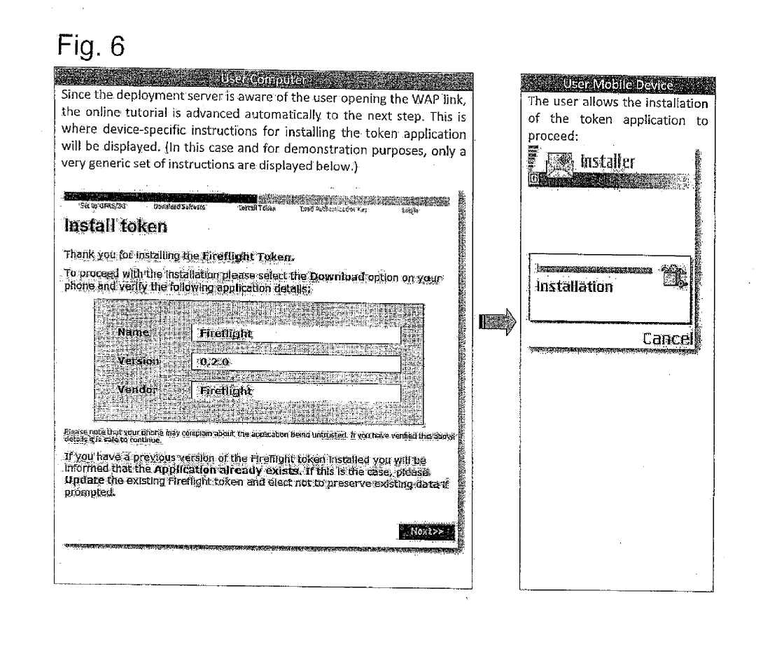

The computer screen now displays the information the user will be confronted with on their mobile device: the application vendor, version and security information is available to the tutorial system to package in a way that best suits the specific phone/mobile device being dealt with. (See FIG. 6.) Once the user has verified the information displayed on the computer and mobile device, the user downloads the application by opting to accept the token application offered by the JAD file. (Exactly how the user does this is mobile device dependent and will thus be explained in detail on the user's computer screen by the tutorial.)

Upon accepting the application, the mobile device will request the JAR file (URL-rewritten by Apache) and the user is served the file appropriate to their device. Upon completion of the installation attempt the outcome will automatically be posted back to the deployment server. In case of failure the user is notified on the computer screen and given a few options to correct the matter or requested to contact the call centre. In case of success the user's computer screen will advance to the configuration stage of deployment. In both cases the outcome is logged in the database.

If e-mail-based reporting is active for the client, then the deployment report will be sent at this stage.

The deployment process is logged in detail on the deployment server. If e-mail reporting is active, then this report will be sent to the turnkey server which initiated the deployment process.

During all deployment steps meticulous logs are kept of all actions, their timestamps and outcomes. This makes it possible to track exactly what went wrong with a specific deployment and creates the opportunity to see how much time users spend on which steps. This in turn makes it possible to see which tutorial pages might need improvement without the user actually having to lodge a complaint.

While the deployment process can be completed successfully in a fully disconnected system, some kind of feedback would make user support and an administrator's life much easier. Information like the outcome of the deployment process (success or failure), the user's device vendor and model, and the version of the installed token can all be used to ease and simplify the user experience. For instance, a user who requests a token synchronization can be helped much more effortlessly if the administrator knows whether or not that user's token supports automatic synchronization, a feature that will only be supported by some mobile computing devices and through which the synchronization occurs without any user input.

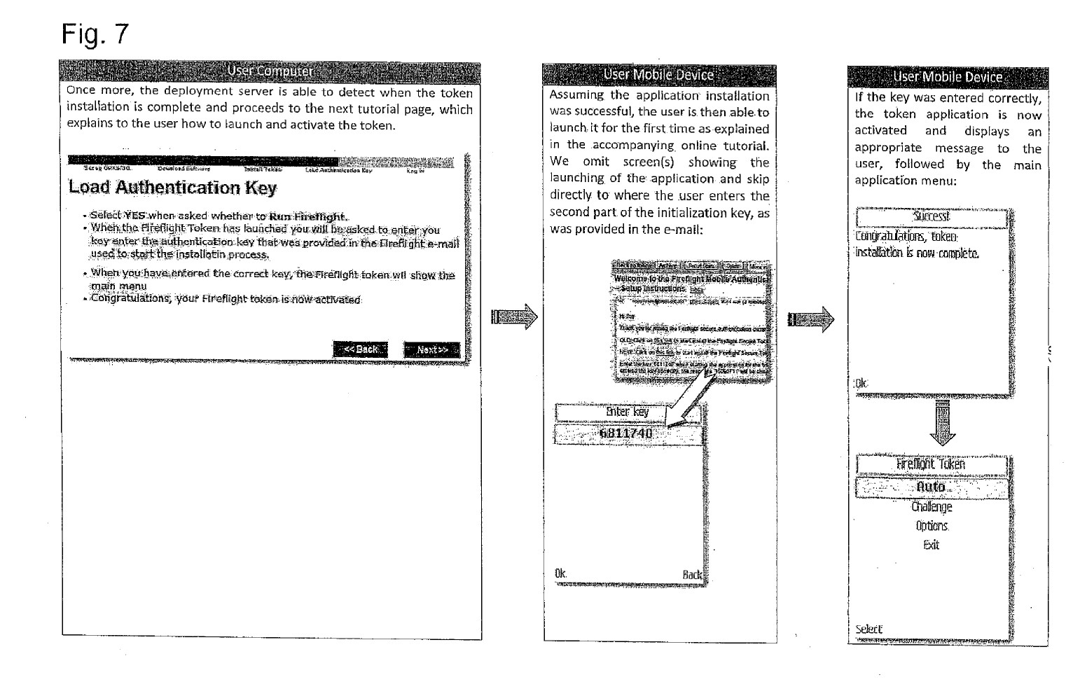

The user selects the installation option on the mobile computing device and, once the installation has been carried out successfully, receives a message on the display of the mobile device to enter the security key provided in the initial invitation e-mail, as shown in FIG. 7. At the same time, the online tutorial is advanced to display suitable instructions. Once the security key has been entered correctly, the security software application is activated and displays a corresponding message to the user, followed by the main application menu.

Again, customized steps are shown for every mobile device and the user is prompted for the second part of the key (from their perspective it is only “the key”). The token application will automatically check the entered key's validity using the Token-Key-Response parameter in the JAD file and display the appropriate message.

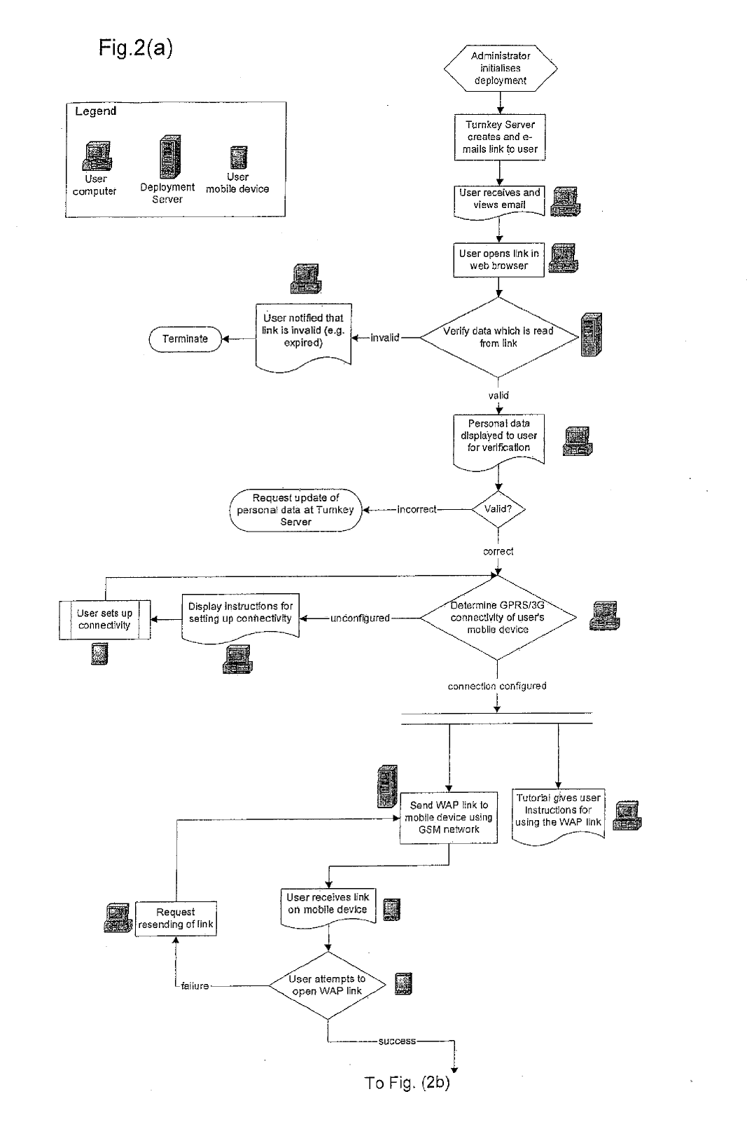

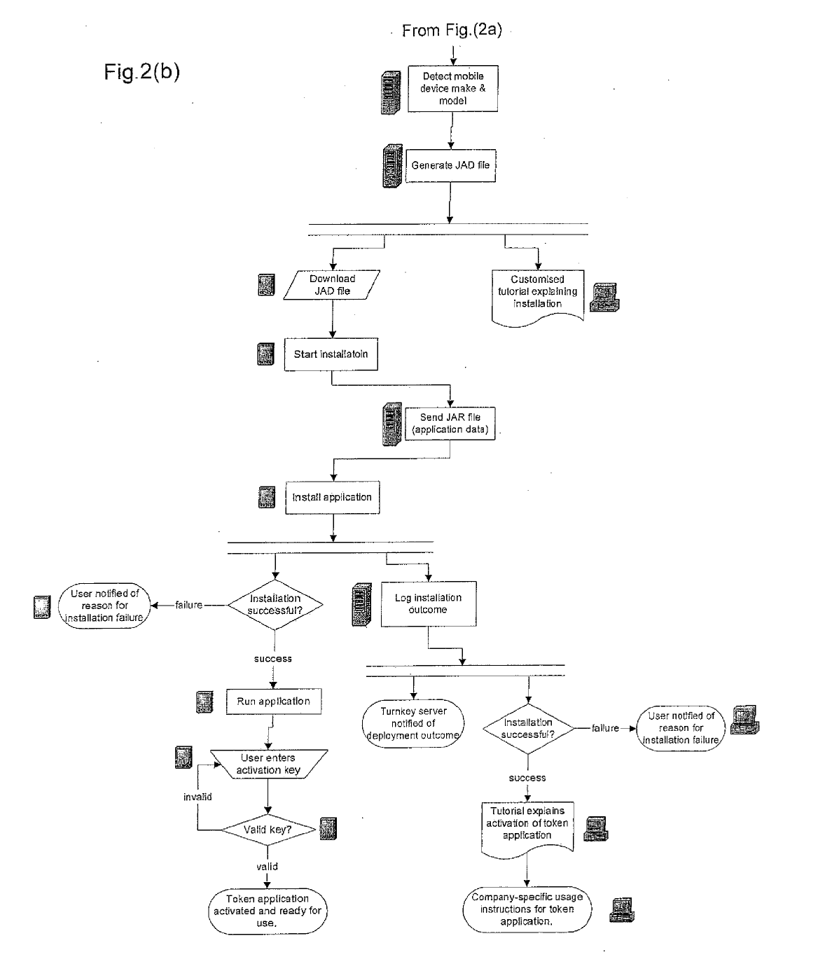

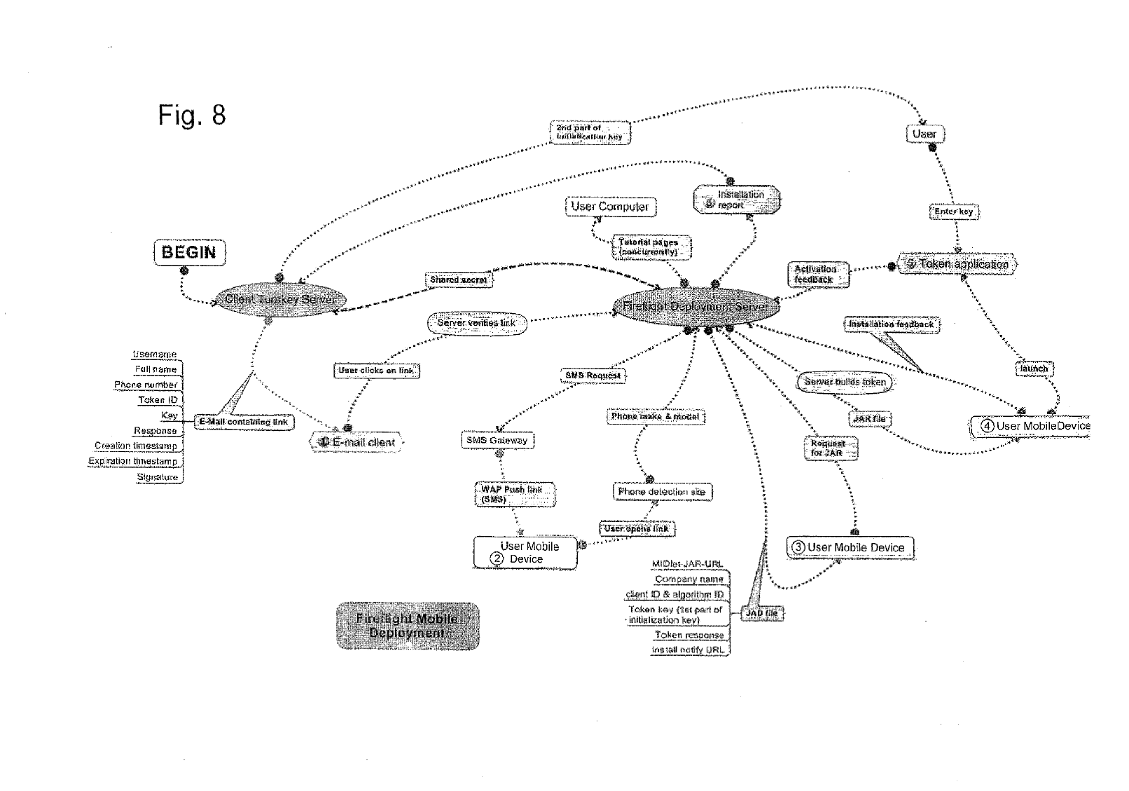

The overall flow of the above described method is shown in the flowchart-type diagrams of FIGS. 2a and 2b, and also in the composite system/process diagram of FIG. 8.

Once the security token application has been installed, the user can operate the mobile computing device as an authentication token for secure access to the network, generating a one-time password whenever access is required. The user's mobile computing device thus can provide the same functionality as a dedicated hardware security token, but without the need for additional hardware cost and the need for the user to carry an additional device.

Apart from the examples given above, possible applications to be deployed could include:
General mobile applications such as games which could benefit from a smooth and automated installation process
Purchased mobile applications which should not be copied or shared and are intended only for a specific recipient.

The described method provides two key features. Firstly, the method provides secure delivery of applications, with activation etc. The application cannot easily be shared or copied. Secondly, the method makes use of an interactive, customized, installation process with device-specific tutorials. The second feature is very nice to have as it makes the installation of nearly any mobile application easier and faster.

The fact that a software application can be delivered securely to a specific phone or other mobile device is useful for security applications (like authentication tokens), but is also useful for any form of subscription/payment based software distribution.

The software is customized for a specific user, and can only be installed on his/her phone, making it very difficult for users to share the software. This process could therefore be used by companies selling mobile software to ensure that their software is delivered to the intended recipients and not stolen/shared by other users.

1. A method of installing a software application on a mobile computing device, the method comprising:
creating an account for a user on a network, the account having user identification data associated therewith including a user name, a user e-mail address and an address of a mobile computing device of the user;
transmitting an invitation message to the user, the invitation including a link to an installation web page;
receiving, at a deployment server supporting said installation web page, an initial request from the user to install the software application;
transmitting data to the mobile computing device of the user and receiving a response from the mobile computing device from which one or more characteristics of the mobile computing device can be determined;
at the deployment server, receiving a confirmatory request from the mobile computing device to install the software application;
transmitting data comprising the software application from the deployment server to the mobile computing device of the user; and
installing the application software on the mobile computing device of the user.

2. The method of claim 1 wherein the mobile computing device of the user is a mobile telephone, a PDA or another mobile computing device with wireless connectivity.

3. The method of claim 1 wherein the software application is security software.

4. The method of claim 3 wherein the software application is a one-time password application.

5. The method of claim 1 wherein the invitation message is sent to the user in the form of an e-mail message transmitted to an e-mail address of the user.

6. The method of claim 5 wherein the invitation message is transmitted from a secure server associated with the network.

7. The method of claim 5 wherein the invitation message is received by a user at a computer terminal of the user other than said mobile computing device.

8. The method of claim 7 wherein the initial request from the user to install the software application is transmitted from said computer terminal of the user other than said mobile computing device.

9. The method of claim 1 wherein the step of receiving a confirmatory request from the user's mobile computing device to install the software application is preceded by transmitting a link to the mobile computing device, the user opening the link via the mobile computing device to make the confirmatory request.

10. The method of claim 9 wherein the link is transmitted from the deployment server to the address of the mobile computing device as a WAP or SMS format message.

11. The method of claim 10 wherein a WAP format message is transmitted first and, if the message is not successfully received, the message is resent as an SMS format message.

12. The method of claim 10 wherein the user transmits the confirmatory request from his or her mobile computing device to the deployment server by following the link in the received WAP or SMS message.

13. The method of claim 1 wherein the step of transmitting an invitation message to the user includes transmitting a security key to the user, and the step of installing the application software on the mobile computing device includes entering the security key transmitted to the user in the invitation message.

14. The method of claim 1 wherein a security key is transmitted or communicated to the user and the step of installing the application software on the mobile computing device includes entering the security key transmitted or communicated to the user, the security key being transmitted or communicated to the user by a method independent of the invitation message.

15. A system for installing a software application on a mobile computing device, the system comprising:
a secure server associated with a network, the network having a plurality of users each having an account with user identification data associated therewith including a user name, a user e-mail address and an address of a mobile computing device of the user; and
a deployment server supporting an application installation web page;
the system being operable to:
create an account for a user on the network;
transmit an invitation message to the user, the invitation including a link to the application installation web page;
receive, at the deployment server, an initial request from the user to install the software application;
transmit data to the mobile computing device of the user and receive a response from the mobile computing device from which one or more characteristics of the mobile computing device can be determined;
receive, at the deployment server, a confirmatory request from the mobile computing device to install the software application;
transmit, from the deployment server, data comprising the software application to the mobile computing device of the user; and
install the application software on the mobile computing device of the user.
